(19) United States
(12) Patent Application Publication
(10) Pub. No.: US 2015/0093981 A1
(43) Pub. Date: Apr. 2, 2015

(54) BLOWER NOISE COMPENSATION

(71) Applicant: Ford Global Technologies, LLC, Dearborn, MI (US)

(72) Inventors: Frank Fusco, Plymouth, MI (US); Manfred Koberstein, Troy, MI (US); Curtis M. Jones, Wixom, MI (US); Alan D. Wallington, Detroit, MI (US)

(73) Assignee: Ford Global Technologies, LLC, Dearborn, MI (US)

(21) Appl. No.: 14/039,143

(22) Filed: Sep. 27, 2013

(51) Int. Cl. B60H 1/00; B60S 1/02

(52) U.S. Cl. CPC B60H 1/00792; B60S 1/023
USPC 454/75

(57) ABSTRACT

A system includes a blower controller that controls the operation of at least one vehicle blower and a processing device that receives a user input associated with operation of the vehicle blower, detects whether a mobile device is in use, and commands the blower controller to control the operation of the at least one vehicle blower according to the user input while the mobile device is in use. A method includes receiving a user input associated with operation of at least one vehicle blower, detecting whether a mobile device is in use, and commanding a blower controller to control the operation of the at least one vehicle blower according to the user input while the mobile device is in use.

### BACKGROUND

Pairing a mobile phone with a vehicle allows a driver to make and receive hands-free telephone calls. Typically, when the mobile phone is paired with the vehicle, the driver can use the vehicle's internal microphone(s) and speakers during calls. Therefore, the driver need not hold the mobile phone near his or her mouth and/or ears during calls or use a headset or headphones. Some vehicles allow the driver to control certain operations of the mobile phone from the vehicle controls. For example, some vehicles allow the driver to increase and/or decrease the volume of the call by adjusting the volume of the vehicle speakers. While using the vehicle's internal microphone and speakers during calls is generally considered a convenience, the microphone can sometimes pick up other sounds in the vehicle (such as from the radio or climate control system), and the mobile phone may transmit those sounds to the person at the other end of the call. In addition, other sounds in the vehicle may interfere with the driver's ability to hear the person on the other end of the call.

### BRIEF DESCRIPTION OF THE DRAWINGS

FIG. 1 illustrates an exemplary system for reducing blower noise in a vehicle when a mobile device is in use.

FIG. 2 illustrates an exemplary graphical user interface that may be used in the system of FIG. 1.

FIG. 3 is a flowchart of an exemplary process that may be implemented by one or more components of the system of FIG. 1.

FIG. 4 is a flowchart of another exemplary process that may be implemented by one or more of the components of the system of FIG. 1.

### DETAILED DESCRIPTION

A system includes a blower controller that controls the operation of at least one vehicle blower and a processing device that receives a user input (e.g., a blower compensation setting) associated with operation of the vehicle blower, detects whether a mobile device is in use, and commands the blower controller to control the operation of the at least one vehicle blower according to the user input while the mobile device is in use. A method includes receiving a user input associated with operation of at least one vehicle blower, detecting whether a mobile device is in use, and commanding a blower controller to control the operation of the at least one vehicle blower according to the user input while the mobile device is in use. Thus, applying the blower compensation setting may automatically reduce blower noise while the mobile device is in use.

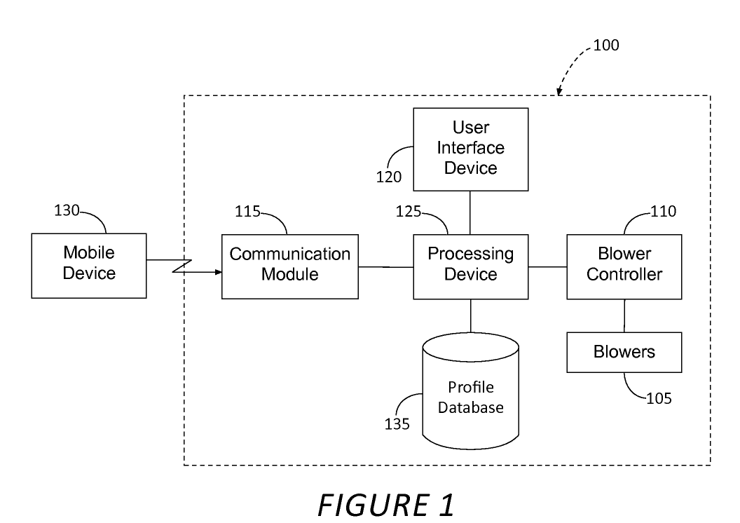

FIG. 1 illustrates an exemplary vehicle 100 capable of reducing blower noise when a mobile device is in use. The system may take many different forms and include multiple and/or alternate components and facilities. While an exemplary system is shown, the exemplary components illustrated are not intended to be limiting. Indeed, additional or alternative components and/or implementations may be used.

As illustrated in FIG. 1, the vehicle 100 may include blowers 105, a blower controller 110, a communication module 115, a user interface device 120, and a processing device 125. The vehicle 100 may be configured to reduce blower noise when a mobile device 130 paired with the vehicle 100 is in use.

The blowers 105 may each be configured to circulate air throughout the passenger compartment of the vehicle 100. In some implementations, at least one blower 105 may circulate air from outside the vehicle 100 to inside the vehicle 100 or recirculate air within the vehicle 100. Each blower 105 may include a fan driven by an electric motor. The rotational speed of the fan may be directly related to the amount of power provided to the electric motor. Moreover, as the fan speed is increased, the volume of air circulated by the blower 105 is increased. In general, the noise created by each blower 105 will increase as the fan speed increases. The vehicle 100 may include any number of blowers 105, and the blowers 105 may be located throughout the vehicle 100.

The blower controller 110 may be configured to control the operation of the blowers 105 in the vehicle 100. The blower controller 110 may cause at least some blowers 105 to operate at different speeds than other blowers 105. The blower controller 110 may even disable certain blowers 105. In general, the blower controller 110 may control the operation of the blowers 105 according to various modes. Each mode may enable a different set of blowers 105. Example modes may include a defrost mode, a heat mode, and an air conditioning mode. In the defrost mode, the blower controller 110 may enable blowers 105 near a windshield of the vehicle 100 to circulate more air than other blowers 105 in the vehicle 100. In the heat mode, the blower controller 110 may enable blowers 105 below the dashboard to circulate more air than other blowers 105 in the vehicle 100. In the air conditioning mode, the blower controller 110 may enable blowers 105 in the dashboard to circulate more air than other blowers 105 in the vehicle 100. In each of these modes, the other blowers 105 in the vehicle 100 may either be turned off or set to a relatively low speed. The operating mode may be selected automatically by the blower controller 110 (or another component of the vehicle 100) or may be based on a user input.

In addition to enabling it different sets of blowers 105, the blower controller 110 may be configured to control the fan speed of each blower 105. That is, the blower controller 110 may increase the power provided to the motor of a particular blower 105 to increase the fan speed and reduce the power provided to the motor of a particular blower 105 to decrease the fan speed. When operating at a maximum fan speed, the blower 105 may be said to be operating in a maximum output mode. The fan speed may be selected automatically by the blower controller 110 and/or may be based on a user input. For example, the blower controller 110 may apply different fan speeds under different conditions, such as when the mobile device 130 is in use (e.g., has received an incoming call or made an outgoing call). Under such circumstances, the blower controller 110 may apply a blower compensation setting set by the user. The blower compensation setting may define a new blower speed or an amount by which the blower speed is to be reduced. By way of example only, the blower compensation setting may define that the blower speed is to be reduced by a user-selected value such as, e.g., 10%, 50%, 80%, etc.

The communication module 115 may be configured to facilitate internal and/or external communications of various components of the vehicle 100. The communication module 115 may implement any number of communication protocols. For example, the communication module 115 may facilitate communication over a controller area network bus for intra-vehicle communication. Moreover, the communication module 115 may implement any number of telecommunications protocols including but not limited to Bluetooth® to permit communication with external devices such as the mobile device 130. The communication module 115 may be further configured to implement any number of handshaking protocols to pair one or more external devices with the vehicle 100.

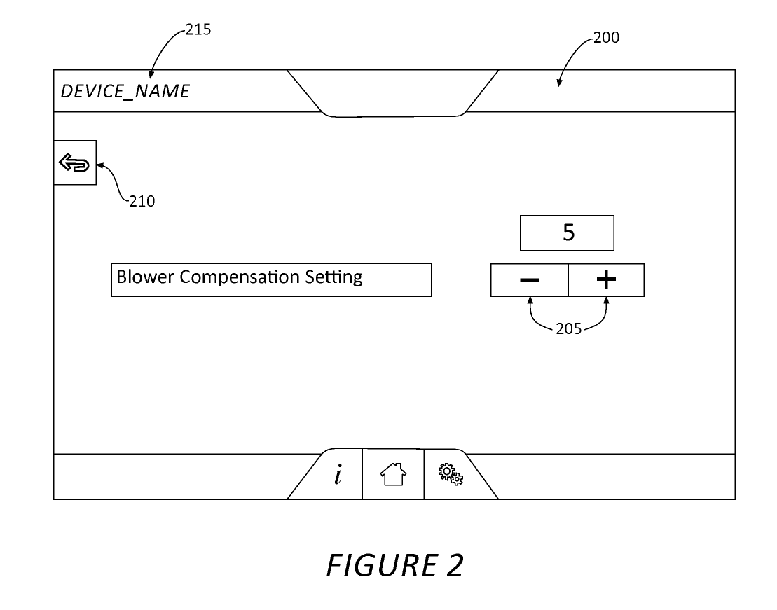

The user interface device 120 may be configured to output information to the user as well as receive user inputs. The user interface device 120 may include a touch-sensitive display screen that presents a graphical user interface to the user. The graphical user interface may include virtual buttons, soft buttons, and/or hard buttons to receive user inputs. Moreover, the user interface device 120 may be used to prompt the user for information. An example graphical user interface prompting the user to provide a blower compensation setting is shown in FIG. 2 and discussed below.

The processing device 125 may be configured to receive a user input, such as the blower compensation setting, associated with the operation of the blowers 105. Because the blower compensation setting is applied when the mobile device 130 is in use, the processing device 125 may be configured to detect whether the mobile device 130 is in use and command the blower controller 110 to control the operation of the blowers 105 accordingly. The processing device 125 may detect whether the mobile device 130 is and use based on whether the mobile device 130 has received an incoming call or meeting outgoing call while paired with the vehicle 100.

It may be possible in some circumstances for the blower controller 110 to ignore the blower compensation setting, especially in circumstances where the operation of the climate control system outweighs noise concerns. Such circumstances may be referred to as exception conditions. The processing device 125 may determine whether an exception condition exists, and if so, command the blower controller 110 to control the blowers 105 accordingly. Examples of exception conditions may include when the blowers 105 are operated in the defrost mode or in the maximum output mode. Under such conditions, the processing device 125 may command the blower controller 110 to ignore the blower compensation setting provided by the user and maintain the operation of the blowers 105 (i.e., as if the mobile device 130 were not in use).

In addition to exception conditions, the processing device 125 may come in the blower controller 110 to ignore the blower compensation setting in response to a user override received via, e.g., the user interface device 120. The user override may include a user input representing the user's desire to operate the fan of one or more of the blowers 105 at a particular speed. The user override may be received any time, including while the mobile device 130 is in use.

The processing device 125 may be configured to save one or more user inputs, including the blower compensation setting, to a profile stored in profile database 135. The processing device 125 may further associate the mobile device 130 with the profile. The mobile device 130 may be associated with profile after the mobile device 130 is paired with the vehicle 100 through, e.g., the communication module 115. When the mobile device 130 is in use, the processing device 125 may be configured to query the profile database 135 for the profile associated with the mobile device 130 and apply the blower compensation setting identified by the profile. When the processing device 125 determines that the mobile device 130 is no longer in use, the processing device 125 may be configured command the blower controller 110 to control the blowers 105 according to a previous setting, which may be different from the blower compensation setting. The user may modify or delete information stored in one or more profiles by providing a user input to the user interface device 120.

The mobile device 130 may include any device capable of pairing with the vehicle 100. In general, the mobile device 130 may be configured to communicate over one or more telecommunications networks, such as a cellular network and/or a packet-switched network, and implement any number of communication protocols, such as the Bluetooth® protocol. In addition or in the alternative, the mobile device 130 may be configured to present media content, such as music, movies, games, etc., to a user. Examples of mobile devices 130 may include a mobile phone, a tablet computer, a laptop computer, handheld video game devices, or the like. Although separate from the vehicle 100, the mobile device 130 may be located inside the vehicle 100, such as inside the passenger compartment of the vehicle 100, when paired with the vehicle 100 through, e.g., the communication module 115.

In general, computing systems and/or devices, such as the blower controller 110, the processing device 125, and the mobile device 130, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores, such as the profile database 135, described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

FIG. 2 illustrates an exemplary graphical user interface 200 that may be presented via the user interface device 120 at or around the time the mobile device 130 is paired with the vehicle 100. The graphical user interface 200 may prompt the user to provide a desired blower compensation setting that will be applied anytime the mobile device 130 is in use in the vehicle 100. In one possible approach, the graphical user interface 200 may include buttons 205 that allow the user to increase or decrease the blower compensation setting. By way of example only, a higher blower compensation setting may be associated with a greater reduction in blower speed. Further, the reduction in blower speed represented by the blower compensation setting may not be transparent to the user. That is, the user may not be aware that a blower compensation setting of, e.g., five (5) may cause a 50% reduction in blower speed while a blower compensation setting of, e.g., seven (7) may cause an 80% reduction in blower speed.

Another button 210 may allow the user to save the selected blower compensation setting and exit the graphical user interface 200. In response to pressing the button 210, the processing device 125 may associate the currently paired mobile device 130 with the blower compensation setting in a user profile and store the user profile in the profile database 135. The buttons 205, 210 are virtual buttons presented via the user interface device 120 in the implementation shown in FIG. 2. In some possible implementations, however the buttons 205, 210 may be soft buttons or hard buttons located in the passenger compartment of the vehicle 100.

The graphical user interface 200 may further present an identifier 215 associated with the mobile device 130. Example identifiers may include a name of the mobile device 130 or an identification number such as a serial number, a Mobile Equipment Identifier (MEID), International Mobile Station Equipment Identity (IMEI) number, or the like.

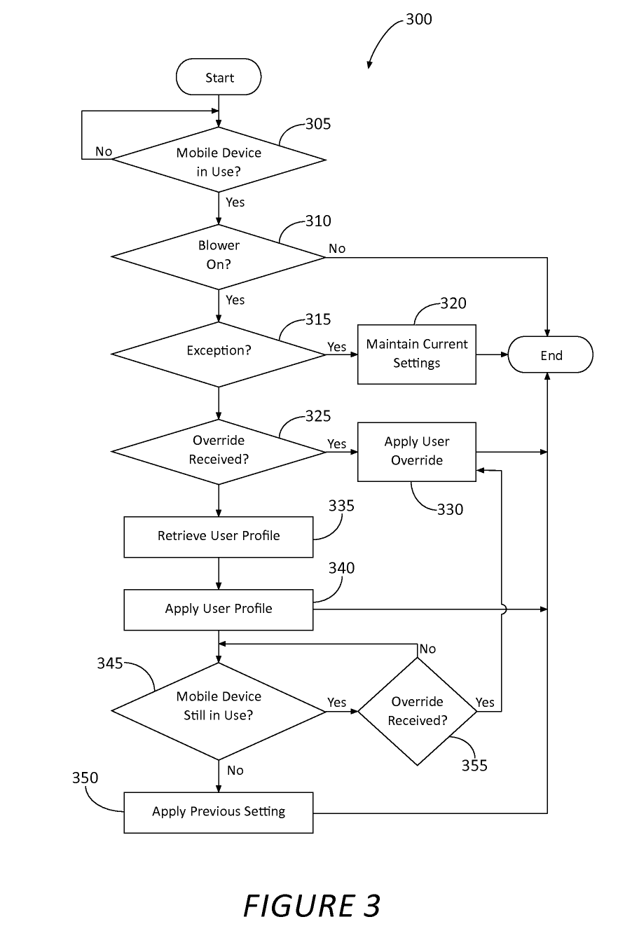

FIG. 3 is a flowchart of an exemplary process 300 and may be implemented by one or more components of the vehicle 100. For instance, the process 300 may be implemented by the processing device 125.

At decision block 305, the processing device 125 may detect whether the mobile device 130 paired with the vehicle 100 is in use. For example, the processing device 125 may determine whether the mobile device 130 has received an incoming call or made an outgoing call. Additionally or in the alternative, the processing device 125 may determine that the mobile device 130 is in use any time the mobile device 130 is outputting sound through speakers of the vehicle 100. If the processing device 125 determines that the mobile device 130 is in use the process 300 may continue at block 310. Decision block 305 may otherwise be repeated until the mobile device 130 is determined to be in use.

At decision block 310, the processing device 125 may determine the state of the blowers 105, including determining whether one or more of the blowers 105 is turned on and the operating mode of the blowers 105. Example operating modes may include a defrost mode, a heat mode, and an air conditioning mode. Whether blowers 105 are turned on and the operating mode may be determined from the blower controller 110. If no blowers 105 are turned on, which may occur if the climate control system of the vehicle 100 is turned off, the process 300 may end. If the processing device 125 determines that one or more blowers 105 are turned on, the process 300 may continue at block 315.

At decision block 315, the processing device 125 may determine whether an exception condition exists. Examples of exception conditions may include instances when the blowers 105 are operated in the defrost mode or in the maximum output mode. Under such conditions, the process 300 may continue at block 320. If no exception conditions exist, the process 300 may continue at block 325.

At block 320, the processing device 125 may command the blower controller 110 to operate the blowers 105 according to a current setting. In other words, the blower compensation setting will not be applied. The process 300 may end after block 320.

At decision block 325, the processing device 125 may determine whether a user override was received. The user override may represent a user's desire for the blower controller 110 to ignore the previously set blower compensation setting. If the user override is received, the process 300 may continue at block 330. If no user override is received, the process 300 may continue at block 335.

At block 330, the processing device 125 may command the blower controller 110 to control the blowers 105 according to a user input setting, which may include the user override. Thus, the blower compensation setting may be ignored when a user input, such as the user override, is received even though the mobile device 130 paired with the vehicle 100 is in use. The process 300 may end after block 330.

At block 335, the processing device 125 may query the profile database 135 for the user profile associated with the mobile device 130 paired with the vehicle 100. As discussed above, the user profile may associate the mobile device 130 with the user's desired blower compensation setting. Therefore, the processing device 125 may query the profile database 135 using an identifier 215 (such as the device name) of the mobile device 130. Moreover, the processing device 125 may access the blower compensation setting defined by the user profile resulting from the query.

At block 340, the processing device 125 may apply the blower compensation setting accessed at block 335. For example, the processing device 125 may command the blower controller 110 to operate the blowers 105 according to the blower compensation setting, which may include reducing a speed of one or more of the blowers 105 by a predetermined amount defined by the blower compensation setting selected by the user. By way of example only, the blower compensation setting may reduce the blower speed by, e.g., 50% while the mobile device 130 is in use and no exception conditions exist and no user overrides have been received.

At decision block 345, the processing device 125 may determine whether the mobile device 130 is still in use. For example, the processing device 125 may determine whether the call is still active or whether the mobile device 130 is still using the speakers of the vehicle 100 to output sound. If the mobile device 130 is no longer in use, the process 300 may continue at block 350. If, however, the mobile device 130 is still in use, the process 300 may continue at block 355.

At block 350, the processing device 125 may command the blower controller 110 to control the operation of the blowers 105 according to a previous setting. The previous setting may include the setting at which the blowers 105 were operating before the blower compensation setting was applied. The process 300 may end after block 350.

At decision block 355, the processing device 125 may determine whether a user override was received after the blower compensation setting was applied and while the mobile device 130 is still in use. If so, the process 300 may continue at block 330 so that the user override may be applied (i.e., the blower controller 110 may operate the blowers 105 according to the user override) while the mobile device 130 is in use.

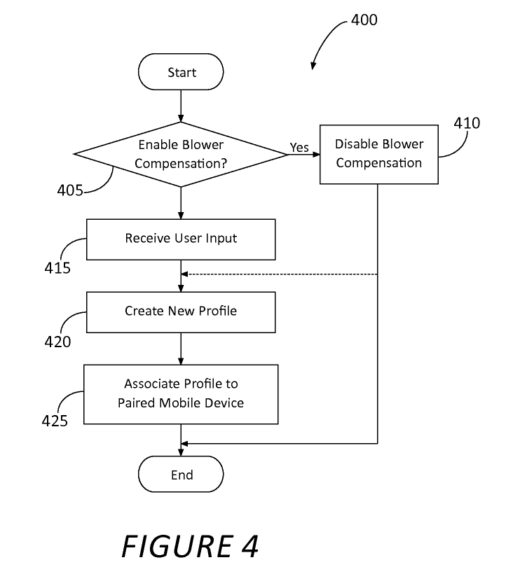

FIG. 4 illustrates a flowchart of a process 400 that may be implemented by, e.g., the processing device 125 at or around the first time the mobile device 130 is paired with the vehicle 100. For example, the process 400 may begin shortly after the mobile device 130 has successfully paired with the vehicle 100.

At decision block 405, the processing device 125 may prompt the user to select whether to enable a blower compensation feature. The blower compensation future may be applied according to the process 300 discussed above with reference to FIG. 3. If the user does not wish to enable the blower compensation feature, the process 400 may continue at block 410. If the user elects to enable the blower compensation feature, the process 400 may continue at block 415.

At block 410, the processing device 125 may disable the blower compensation feature. One way to disable the blower compensation feature may include setting the blower compensation setting to zero (0). When the blower compensation setting is set to zero (0) the blower speed may not change when the blower compensation setting is applied as discussed above with regard to the process 300 shown in FIG. 3. Thus, setting the blower compensation setting to zero effectively disables the blower compensation feature. The process 400 may end after block 410, or in some possible implementations, the process 400 may continue at block 420 using the blower compensation setting of zero (0) stored in the user profile.

At block 415, the processing device 125 may receive a user input representing the desired blower compensation setting. For instance, as discussed above with reference to FIG. 2, the user input may select the desired blower compensation setting via the user interface device 120.

At block 420, the processing device 125 may create a new user profile that includes the blower compensation setting. The user profile may be stored in the profile database 135.

At block 425, the processing device 125 may associate the user profile created at block 420 with the mobile device 130 paired with the vehicle 100. Therefore, the user profile may be accessed from the profile database 135 any time while the mobile device 130 is paired with the vehicle 100. Moreover, by associating the user profile to a mobile device 130, the processing device 125 may determine which blower compensation setting to apply based on the mobile device 130 paired with the vehicle 100.

The process 400 may end after block 425.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A system comprising:
a blower controller configured to control operation of at least one vehicle blower;
a processing device configured to receive a user input associated with operation of the vehicle blower, detect whether a mobile device is in use, and command the blower controller to control the operation of the at least one vehicle blower according to the user input while the mobile device is in use.

2. The system of claim 1, wherein detecting whether the mobile device is in use includes the processing device determining whether the mobile device has received an incoming call or made an outgoing call.

3. The system of claim 1, wherein the processing device is configure to determine whether an exception condition exists and command the blower controller to control the vehicle blower according to the exception condition.

4. The system of claim 3, wherein the exception condition exists when the vehicle blower is operating in a defrost mode or a maximum output mode.

5. The system of claim 3, wherein the processing device is configured to command the blower controller to maintain the operation of the at least one vehicle blower when the exception condition exists.

6. The system of claim 1, wherein the processing device is configured to receive a user override and command the blower controller to control the operation of the vehicle blower according to the user override at least while the mobile device is in use.

7. The system of claim 1, wherein the processing device is configured to save the user input to a user profile and query a profile database for the user profile.

8. The system of claim 7, further comprising a communication module configure to pair with the mobile device, and wherein the processing device is configured to associate the user profile to the mobile device paired with the communication module.

9. The system of claim 1, wherein the processing device is configured to determine that the mobile device is no longer in use and command the blower controller to control the operation of the at least one blower according to a previous setting when the mobile device is no longer in use.

10. A method comprising
receiving a user input associated with operation of at least one vehicle blower;
detecting whether a mobile device is in use; and
commanding, via computing device, a blower controller to control the operation of the at least one vehicle blower according to the user input while the mobile device is in use.

11. The method of claim 10, wherein detecting whether the mobile device is in use includes determining, via the computing device, whether the mobile device has received an incoming call or made an outgoing call.

12. The method of claim 10, further comprising:
determining whether an exception condition exists; and
commanding the blower controller to control the vehicle blower according to the exception condition.

13. The method of claim 12, wherein the exception condition exists when the vehicle blower is operating in a defrost mode or a maximum output mode.

14. The method of claim 12, wherein commanding the blower controller according to the exception condition includes commanding the blower controller to maintain the operation of the at least one vehicle blower when the exception condition exists.

15. The method of claim 10, further comprising:
receiving a user override; and
commanding the blower controller to control the operation of the vehicle blower according to the user override at least while the mobile device is in use.

16. The method of claim 10, further comprising:
saving the user input to a user profile associated with the mobile device; and
querying a profile database for the user profile.

17. The method of claim 10, further comprising:
determining that the mobile device is no longer in use; and
commanding the blower controller to control the operation of the at least one blower according to a previous setting when the mobile device is no longer in use.

18. A non-transitory computer-readable medium tangibly embodying computer-executable instructions that cause a processor to execute operations comprising:
receiving a user input associated with operation of at least one vehicle blower;
saving the user input to a user profile associated with a paired mobile device;
detecting whether a mobile device is in use;
querying a profile database for the user profile;
commanding a blower controller to control the operation of the at least one vehicle blower according to the user input while the mobile device is in use;
determining that the mobile device is no longer in use; and
commanding the blower controller to control the operation of the at least one blower according to a previous setting when the mobile device is no longer in use.

19. The non-transitory computer-readable medium of claim 18, wherein detecting whether the mobile device is in use includes determining whether the mobile device has received an incoming call or made an outgoing call.

20. The non-transitory computer-readable medium of claim 18, further comprising:
determining whether an exception condition exists;
determining whether a user override has been received; and
commanding the blower controller to maintain the operation of the vehicle blower if the exception condition exists or the user override was received.
